(19) United States
(12) Patent Application Publication
(10) Pub. No.: US 2024/0356081 A1
(43) Pub. Date: Oct. 24, 2024

(54) ELECTROLYTIC SOLUTION FOR ZINC BATTERY AND ZINC BATTERY

(71) Applicant: ENERGYWITH COMPANY, LIMITED, Tokyo (JP)

(72) Inventor: Kunihiro KUSHIBE, Tokyo (JP)

(21) Appl. No.: 18/685,455

(22) PCT Filed: Aug. 26, 2022
(86) PCT No.: PCT/JP2022/032286

§ 371 Date: Feb. 21, 2024

(30) Foreign Application Priority Data
Aug. 27, 2021 (JP) 2021-138859

(51) Int. Cl. H01M 10/0568; H01M 10/0567; H01M 10/36

(52) U.S. Cl. CPC H01M 10/0568; H01M 10/0567; H01M 10/36

(57) ABSTRACT

The electrolytic solution for a zinc battery contains an alkali metal hydroxide and a surfactant, in which a content of the surfactant is 0.01% by mass or more with respect to a total mass of the electrolytic solution for a zinc battery. A zinc battery contains a positive electrode, a negative electrode, and the electrolytic solution for a zinc battery.

### TECHNICAL FIELD

The present invention relates to an electrolytic solution for a zinc battery and a zinc battery.

### BACKGROUND ART

A nickel-zinc battery, a zinc-air battery, a silver-zinc battery or the like are known as a zinc battery.

For example, a nickel-zinc battery is a water-based battery that uses an aqueous electrolytic solution such as an aqueous potassium hydroxide solution, and therefore, it is highly safe. In addition, it is known that a combination of a zinc electrode and a nickel electrode produces a higher electromotive force for a water-based battery. Furthermore, since a nickel-zinc battery has excellent input-output performance and is low cost, it is being considered for use in industrial applications such as backup power supplies and automotive applications such as hybrid vehicles.

A charging and discharging reaction of a nickel-zinc battery proceeds, for example, according to the following formula (discharging reaction: rightward, charging reaction: leftward).

(Positive electrode) 2NiOOH+2H₂O+2e⁻→2Ni(OH)₂+2OH⁻

(Negative electrode) Zn+2OH⁻→Zn(OH)₂+2e⁻

As shown in the above formula, zinc hydroxide (Zn(OH)₂) is produced by a discharge reaction in a zinc battery. Zinc hydroxide is soluble in the electrolytic solution, and in a case in which zinc hydroxide is dissolved in the electrolytic solution, tetrahydroxide zincate ions ([Zn(OH)₄]²⁻) diffuse into the electrolytic solution. As a result, a shape change (deformation) of the negative electrode progresses and a charging current distribution becomes uneven, whereby zinc deposition occurs locally on the negative electrode, and a dendrite (dendritic crystal) is generated. In conventional zinc battery, in a case in which the dendrite grows due to repeated charging and discharging, the dendrite may pass through a separator and cause a short circuit. Therefore, various attempts have been made to prevent short circuits caused by dendrites so as to improve life performance. For example, Patent Document 1 discloses a nickel-zinc battery characterized by being equipped with an electrolytic solution containing saccharides.

### PRIOR ART DOCUMENT

### Patent Documents

Patent Document 1: Japanese Patent Application Laid-Open (JP-A) No.2021-77594

### SUMMARY OF INVENTION

Zinc battery is sometimes used in low-temperature environments such as 0° C. to −30° C., and are required to improve their life performance and suppress deterioration in low-temperature discharge performance.

One aspect in the present invention is to provide an electrolytic solution for a zinc battery that can suppress deterioration in low-temperature discharge performance of a zinc battery. Another aspect in the present invention is to provide a zinc battery containing the electrolytic solution for a zinc battery.

### Solution to Problem

Specific embodiments for solving the above-described problems includes the following embodiments.
<1> An electrolytic solution for a zinc battery containing an alkali metal hydroxide and a surfactant,
in which a content of the surfactant is 0.01% by mass or more with respect to a total mass of the electrolytic solution for a zinc battery.
<2> The electrolytic solution for a zinc battery according to <1>, in which the alkali metal hydroxide contains potassium hydroxide.
<3> The electrolytic solution for a zinc battery according to <1> or <2>, in which the surfactant includes at least one selected from the group consisting of a cationic surfactant, a nonionic surfactant and an anionic surfactant.
<4> The electrolytic solution for a zinc battery according to any one of <1> to <3>, further containing an organic compound containing an oxygen atom.
<5> The electrolytic solution for a zinc battery according to <4>, in which the organic compound containing an oxygen atom includes at least one selected from the group consisting of a carboxy group, a carboxylate salt group, a hydroxyl group, an epoxy group and an ether group.
<6> The electrolytic solution for a zinc battery according to <4> or <5>, in which the organic compound containing an oxygen atom comprises an ether compound having a heterocycle containing an ether group.
<7> The electrolytic solution for a zinc battery according to any one of <4> to <6>, in which the organic compound containing an oxygen atom includes an ether compound represented by the following Formula (3),

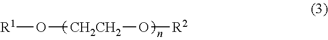

in which, in Formula (3), n represents an integer of from 1 to 10, and each of R¹ and R² represents an organic group.
<8> The electrolytic solution for a zinc battery according to <7>, in which each organic group in Formula (3) is an alkyl group or an aryl group.
<9> The electrolytic solution for a zinc battery according to <7> or <8>, in which the ether compound represented by Formula (3) includes a glyme compound.
<10> The electrolytic solution for a zinc battery according to <9>, in which the glyme compound includes at least one selected from the group consisting of a monoglyme, a diglyme, a triglyme and a tetraglyme.
<11> A zinc battery, containing a positive electrode, a negative electrode, and the electrolytic solution for a zinc battery according to any one of <1> to <10>.

### Advantageous Effects of Invention

According to one aspect in the present invention, it is possible to provide an electrolytic solution for a zinc battery that can suppress deterioration in low-temperature discharge performance of zinc battery. According to another aspect in the present invention, it is possible to provide a zinc battery containing the electrolytic solution for a zinc battery.

### DESCRIPTION OF EMBODIMENTS

In the present disclosure, the numerical range indicated using “to” includes the numerical values before and after “to” as the minimum and maximum values, respectively. In the present disclosure, in the numerical ranges described step by step in the present disclosure, the upper limit or lower limit of one numerical range may be replaced with the upper or lower limit of another numerical range described step by step. Moreover, in the numerical ranges described in the present disclosure, the upper or lower limits of the numerical ranges may be replaced with the values shown in the examples. “A or B” may include either A or B, or may include both. Materials exemplified in the present disclosure may be used singly or in combination of two or more, unless otherwise specified. In a case in which there are multiple types of substances corresponding to each component in the composition, an amount of each component means a total amount of the multiple types of substances present in the composition, unless otherwise specified. In the present disclosure, the term “layer” or “film” encompasses the case where the layer or film is formed in the entire region and the case where the layer or film is formed in only a part of the region, when observing the region where the layer or film is present. In the present disclosure, the term “process” includes not only a process which is independent from another process, but also a process which is not clearly distinguishable from another process, as long as a purpose of the process can be achieved.

Hereinafter, embodiments in the present invention will be described in detail. However, the present invention is not limited to the following embodiments, and can be implemented with various modifications within the scope.

An electrolytic solution for a zinc battery (hereinafter sometimes referred to as simply “electrolytic solution”) in the present embodiment is used as an electrolytic solution for a zinc battery (for example, zinc secondary battery). The zinc battery in the present embodiment includes a positive electrode, a negative electrode, and an electrolytic solution in the present embodiment. A zinc battery may include a zinc electrode as a negative electrode. Examples of the zinc battery include nickel-zinc battery whose positive electrode is a nickel electrode (for example, nickel-zinc secondary battery); zinc-air battery whose positive electrode is an air electrode (for example, zinc-air secondary battery); and silver-zinc battery whose positive electrode is a silver oxide electrode (for example, silver-zinc secondary battery).

The electrolytic solution in the present embodiment is an electrolytic solution for a zinc battery, the electrolytic solution containing an alkali metal hydroxide and a surfactant, in which a content of the surfactant is 0.01% by mass or more with respect to a total mass of the electrolytic solution for a zinc battery. According to the electrolytic solution in the present embodiment, it is possible to suppress deterioration in the low-temperature discharge performance of zinc battery, for example, it is possible to reduce a direct current resistance (hereinafter sometimes referred to as DCR) when a zinc battery is discharged in an environment of −30° C.

Factors that can provide such effects include, for example, the following factors, but are not limited to the following factors. Regarding conventional zinc battery, it is thought that it is difficult for the electrolytic solution to spread uniformly over the surface of the active material (zinc component) of the zinc electrode, and the active material that does not come into contact with the electrolytic solution becomes inactive, which causes the direct current resistance to increases during discharge. On the contrary, regarding a zinc battery using the electrolytic solution in the present embodiment, it is thought that the surfactant described above improves the spread of the electrolytic solution to the surface of the active material, thereby reducing a direct current resistance during discharge.

Examples of the alkali metal hydroxide include potassium hydroxide (KOH), sodium hydroxide (NaOH), lithium hydroxide (LiOH), and the like. The alkali metal hydroxide may be ionized (dissociated) in an aqueous solution or may exist as a salt. The alkali metal hydroxide preferably includes at least one selected from the group consisting of potassium hydroxide and lithium hydroxide, and more preferably includes potassium hydroxide, from the viewpoint of easily suppressing the decrease in discharge capacity when storing the zinc battery and from the viewpoint of easily obtaining excellent high rate discharge performance.

A content of the alkali metal hydroxide (total mass of alkali metal hydroxides) in the electrolytic solution based on the total mass of the electrolytic solution is preferably within the following ranges, from the viewpoint of easily suppressing a decrease in discharge capacity when storing zinc battery, and from the viewpoint of easily obtaining excellent high rate discharge performance. The content of the alkali metal hydroxide is preferably 10% by mass or more, 15% by mass or more, 20% by mass or more, 25% by mass or more, or 30% by mass or more. The content of the alkali metal hydroxide is preferably 50% by mass or less, 45% by mass or less, 40% by mass or less, or 35% by mass or less. From these viewpoints, the content of the alkali metal hydroxide is preferably from 10 to 50% by mass.

A content of potassium hydroxide in the electrolytic solution based on the total mass of the electrolytic solution is preferably within the following ranges, from the viewpoint of easily suppressing a decrease in discharge capacity when storing zinc battery, and from the viewpoint of easily obtaining excellent high rate discharge performance. The content of potassium hydroxide is preferably 10% by mass or more, 15% by mass or more, 20% by mass or more, 25% by mass or more, or 30% by mass or more. The content of potassium hydroxide is preferably 50% by mass or less, 45% by mass or less, 40% by mass or less, or 35% by mass or less. From these viewpoints, the content of potassium hydroxide is preferably from 10 to 50% by mass.

A content of lithium hydroxide in the electrolytic solution based on the total mass of the electrolytic solution is preferably within the following ranges, from the viewpoint of easily suppressing a decrease in discharge capacity when storing zinc battery, and from the viewpoint of easily obtaining excellent high rate discharge performance. The content of lithium hydroxide is preferably 0.1% by mass or more, 0.3% by mass or more, 0.5% by mass or more, 0.8% by mass or more, or 1% by mass or more. The content of lithium hydroxide is preferably 3% by mass or less, 2% by mass or less, 1.5% by mass or less, or 1.2% by mass or less. From these viewpoints, the content of lithium hydroxide is preferably 0.1 to 3% by mass.

The electrolytic solution in the present embodiment contains a surfactant. Examples of the surfactant include a cationic surfactant, a nonionic surfactant (not ionic surfactant), an anionic surfactant, amphoteric surfactants, and the like. The surfactant preferably includes at least one selected from the group consisting of a cationic surfactant, a nonionic surfactant and an anionic surfactant, from the viewpoint of easily suppressing deterioration of low-temperature discharge performance of the zinc battery. The surfactant preferably includes a cationic surfactant, preferably includes a nonionic surfactant, and preferably includes an anionic surfactant.

The cationic surfactant has a cationic hydrophilic group and a hydrophobic group. Examples of the cationic surfactant include an aliphatic amine, or a quaternary ammonium salt such as an aliphatic amine salt, an alkylamide amine salt, a monoalkyltrimethylammonium salt, a dialkyldimethylammonium salt, an alkylbenzyldimethylammonium salt, an alkylpyridinium salt, and benzethonium chloride salt. From the viewpoint of easily suppressing deterioration of low-temperature discharge performance of zinc battery, the cationic surfactant preferably includes at least one selected from the group consisting of a monoalkyltrimethylammonium salt and a dialkyldimethylammonium salt, and more preferably includes a monoalkyltrimethylammonium salt.

The monoalkyltrimethylammonium salt and the dialkyldimethylammonium salt have, for example, a structure represented by the following Formula (2).

(R^{2a})ₙN⁺(R^{2b})₄₋ₙX⁻ . . . (2)

[In Formula (2), n is 1 or 2, each of R^{2a} and R^{2b} is independently a hydrocarbon group having from 1 to 20 carbon atoms, and X⁻ is an anion. In a case in which n is 2, the plural R^{2a}s may be the same or different. The plural R^{2b}s may be the same or different.]

The hydrocarbon group of R^{2a} may be linear or branched, saturated or unsaturated, and may include a cyclic structure such as an alicyclic structure. The hydrocarbon group of R^{2a} is preferably an alkyl group. A number of a carbon atom(s) in the hydrocarbon group of R^{2a} is preferably from 12 to 18, and more preferably from 14 to 16. The hydrocarbon group of R^{2b} may be linear or branched, and may be saturated or unsaturated. The hydrocarbon group of R^{2b} is preferably an alkyl group. A number of a carbon atom(s) in the hydrocarbon group of R^{2b} is preferably from 1 to 4, and more preferably 1, 2 or 3. X may be any anion as long as it can form a salt with the quaternary ammonium ion of Formula (2), for example, a halide ion such as F⁻, Cl⁻, Br⁻, I⁻; a carboxylate ion such as CH₃COO⁻ ion; a sulfate ion; or a phosphate ion.

Specific examples of the monoalkyltrimethylammonium salt include dodecyltrimethylammonium bromide, dodecyltrimethylammonium chloride, tridecyltrimethylammonium bromide, tridecyltrimethylammonium chloride, tetradecyltrimethylammonium bromide, tetradecyltrimethylammonium chloride, pentadecyltrimethylammonium bromide, pentadecyltrimethylammonium chloride, hexadecyltrimethylammonium bromide, hexadecyltrimethylammonium chloride, heptadecyltrimethylammonium bromide, heptadecyltrimethylammonium chloride, octadecyltrimethylammonium bromide, or octadecyltrimethylammonium chloride.

Specific examples of the dialkyldimethylammonium salt include didodecyldimethylammonium bromide, didodecyldimethylammonium chloride, ditridecyldimethylammonium bromide, ditridecyldimethylammonium chloride, ditetradecyldimethylammonium bromide, ditetradecyldimethylammonium chloride, dipentadecyldimethylammonium bromide, dipentadecyldimethylammonium chloride, dihexadecyldimethylammonium bromide, dihexadecyldimethylammonium chloride, diheptadecyldimethylammonium bromide, diheptadecyldimethylammonium chloride, dioctadecyldimethylammonium bromide, or dioctadecyldimethylammonium chloride.

The nonionic surfactant has a nonionic hydrophilic group and a hydrophobic group. Examples of the nonionic surfactant include a polyoxyethylene-containing ester compound such as a polyoxyethylene fatty acid ester, a polyoxyethylene sorbitan fatty acid ester, or a polyoxyethylene sorbitol fatty acid ester; a polyoxyethylene-containing ester ether compound such as a polyoxyethylene alkyl ether, or polyoxyethylene alkyl phenyl ether.

The nonionic surfactant preferably includes at least one selected from the group consisting of a polyoxyethylene alkyl ether and a polyoxyethylene alkyl phenyl ether, and more preferably includes a polyoxyethylene alkyl phenyl ether, from the viewpoint of easily suppressing deterioration of low-temperature discharge performance of the zinc battery. The polyoxyethylene alkyl ether has, for example, a structure represented by the following Formula (1a).

R^{1a}O(CH₂CH₂O)ₘ₁H . . . (1a)

[In Formula (1a), m1 is an integer of from 2 to 60, and R^{1a} is a hydrocarbon group having from 1 to 30 carbon atoms.]

The polyoxyethylene alkylphenyl ether has, for example, a structure represented by the following Formula (1b).

R^{1b}C₆H₄O(CH₂CH₂O)ₘ₂H . . . (1b)

[In Formula (1b), m2 is an integer of from 2 to 60, and R^{1b} is a hydrocarbon group having 1 to 30 carbon atoms.]

The hydrocarbon groups of R^{1a} and R^{1b} may be linear or branched, and may be saturated or unsaturated. The hydrocarbon group of R^{1a} and R^{1b} is preferably an alkyl group. A number of a carbon atom(s) in the hydrocarbon group of R^{1a} is preferably from 10 to 18. A number of a carbon atom(s) in the hydrocarbon group of R^{1b} is preferably from 4 to 12, more preferably from 6 to 10, and still more preferably 8. m1 and m2 are average degrees of polymerization, preferably from 5 to 12, and more preferably from 7 to 10.

Specific examples of the polyoxyethylene alkyl ether include polyoxyethylene decyl ether, polyoxyethylene undecyl ether, polyoxyethylene dodecyl ether, polyoxyethylene tridecyl ether, polyoxyethylene tetradecyl ether, polyoxyethylene pentadecyl ether, polyoxyethylene hexadecyl ether, polyoxyethylene heptadecyl ether and polyoxyethylene octadecyl ether.

Specific examples of the polyoxyethylene alkyl phenyl ether include polyoxyethylene octyl phenyl ether and polyoxyethylene nonyl phenyl ether.

The anionic surfactant has an anionic hydrophilic group and a hydrophobic group. Examples of the anionic surfactant include a polyoxyalkylene alkyl ether phosphate (for example, a polyoxyethylene alkyl ether phosphate), a polyoxyethylene alkyl ether sulfate salt, sodium dodecylbenzenesulfonate, an alkali salt of styrene-acrylic acid copolymer, a sodium alkylnaphthalene sulfonate, a sodium alkyldiphenyl ether disulfonate, monoethanolamine lauryl sulfate, triethanolamine lauryl sulfate, ammonium lauryl sulfate, monoethanolamine stearate, sodium stearate, sodium lauryl sulfate, or monoethanolamine of styrene-acrylic acid copolymer. The anionic surfactant preferably includes a polyoxyalkylene alkyl ether phosphate, and more preferably a polyoxyethylene alkyl ether phosphate, from the viewpoint of easily suppressing deterioration of low-temperature discharge performance of the zinc battery.

In a case in which the surfactant includes a cationic surfactant, a nonionic surfactant or an anionic surfactant, a content of the cationic surfactant, the nonionic surfactant or the anionic surfactant in the surfactant is preferably 50% by mass or more, 70% by mass or more, and 90% by mass or more, 95% by mass or more, 97% by mass or more, or 99% by mass or more, based on a content of the surfactant (a total mass of the surfactant), from the viewpoint of easily suppressing deterioration in charge acceptance of the zinc battery. The surfactant may consist essentially of the nonionic surfactant, the anionic surfactant or the cationic surfactant (that is, an embodiment in which the content of the nonionic surfactant, the anionic surfactant or the cationic surfactant is substantially 100% by mass in the surfactant).

A content of the surfactant (a total mass of the surfactant) in the electrolytic solution is preferably 0.01% by mass or more based on a total mass of the electrolytic solution. From the viewpoint of suppressing deterioration in a discharge performance of the zinc battery, the content of the surfactant is preferably 0.05% by mass or more, 0.06% by mass or more, 0.07% by mass or more, 0.08% by mass or more, or 0.1% by mass or more. From the viewpoint of suppressing deterioration in a discharge performance of zinc battery, the content of the surfactant is preferably 5% by mass or less, 2.5% by mass or less, 1% by mass or less, 0.7% by mass or less, or 0.5% by mass. From these viewpoints, the content of the surfactant is preferably from 0.01 to 5% by mass. The content of the surfactant is particularly preferably from 0.1 to 5% by mass from the viewpoint of suppressing deterioration in a discharge performance of zinc battery.

In a case in which the surfactant includes a cationic surfactant, a nonionic surfactant or an anionic surfactant, a content of the cationic surfactant, a content of the nonionic surfactant or a content of the anionic surfactant in the electrolytic solution is preferably 0.01% by mass or more, 0.05% by mass or more, and 0.06% by mass or more, 0.07% by mass or more, 0.08% by mass or more, or 0.1% by mass or more, based on a total mass of the electrolytic solution, from the viewpoint of easily suppressing deterioration in a discharge performance of zinc battery. The content of the surfactant is preferably 5% by mass or less, 2.5% by mass or less, 1% by mass or less, 0.7% by mass or less, or 0.5% by mass. From these viewpoints, the content of the surfactant is particularly preferably from 0.1 to 5% by mass.

The electrolytic solution in the present embodiment may contain an organic compound containing an oxygen atom (excluding compounds corresponding to an alkali metal hydroxide or a surfactant; hereinafter also referred to as “oxygen-containing compound”). The oxygen-containing compound may have a functional group containing oxygen atom. Examples of the functional group containing oxygen atom include a carboxyl group, a carboxylic acid salt group, a hydroxyl group (excluding OH structures included in a carboxyl group), an epoxy group, an ether group, an alkoxide group, an ester group, a ketone group, an aldehyde group. The oxygen-containing compound preferably has at least one selected from the group consisting of a carboxy group, a carboxylic acid salt group, a hydroxyl group, an epoxy group or an ether group, from the viewpoint of easily suppressing a deterioration in a discharge capacity when storing zinc battery, and from the viewpoint of easily obtaining excellent high-rate discharge performance.

In a case in which the oxygen-containing compound has an OH structure, a ratio (number of OH structure(s)/number of carbon atom(s)) of a number of OH structure(s) to a number of carbon atom(s) in the oxygen-containing compound is the following ranges are preferable, from the viewpoint of easily suppressing deterioration in discharge capacity when storing the zinc battery and from the viewpoint of easily obtaining excellent high rate discharge performance. The ratio is preferably 0.01 or more, 0.03 or more, 0.05 or more, 0.1 or more, 0.2 or more, 0.3 or more, 0.4 or more, 0.5 or more, 0.6 or more, 0.7 or more, 0.8 or more, or 5/6 or more. The ratio is preferably 2 or less, 1.5 or less, 1.2 or less, 1 or less, 0.9 or less, or 5/6 or less. From these viewpoints, the ratio (number of OH structure(s)/number of carbon atom(s)) is preferably 0.01 to 2. The oxygen-containing compound may have no OH structure.

The oxygen-containing compound preferably includes at least one selected from the group consisting of a saccharide, a carboxylic acid (excluding a compound that fall under a saccharide), an epoxy compound (a compound that have an epoxy group; excluding a compound that fall under a saccharide, a carboxylic acid or a carboxylate salt), and an ether compound (a compound that have an ether group; excluding a compound that fall under a saccharide, a carboxylic acid, a carboxylate salt or an epoxy compound), from the viewpoint of easily suppressing deterioration in discharge capacity when storing the zinc battery and from the viewpoint of easily obtaining excellent high rate discharge performance.

As the saccharide, a monosaccharide, a disaccharide, a trisaccharide, a polysaccharide (excluding a saccharide falling under a disaccharide or a trisaccharide), or the like can be used. Examples of the monosaccharide include glucose, fructose, galactose, arabinose, ribose, mannose, xylose, sorbose, rhamnose, fucose, ribodesose, or hydrates thereof. Examples of the disaccharide include sucrose, maltose, trehalose, cellobiose, gentiobiose, lactose, melibiose, or hydrates thereof. Examples of the trisaccharide include kestose, meletitose, gentianose, raffinose, gentianose, or hydrates thereof. Examples of the polysaccharide include cyclodextrin (for example, γ-cyclodextrin), stachyose or the like. Moreover, the saccharide preferably contains non-reducing saccharide, from the viewpoint of easily suppressing deterioration in discharge capacity when storing the zinc battery, and from the viewpoint of easily obtaining excellent high-rate discharge performance.

The non-reducing saccharide refers to a saccharide that do not have free reducing groups compared to a reducing saccharide (which is a saccharide with a free aldehyde group or ketone group, or a hemiacetal-bonded aldehyde group or ketone group (Chemical Large Dictionary, 1st edition, published by Tokyo Kagaku Doujin Co., Ltd.). That is, a non-reducing saccharide means a saccharide having neither a free aldehyde group or ketone group nor a hemiacetal-bonded aldehyde group or ketone group. The non-reducing saccharide may be a hydrate.

The non-reducing saccharide includes disaccharides such as sucrose, trehalose, or their hydrates; a trisaccharide such as kestose, meletitose, gentianose, or their hydrates; a tetrasaccharide such as fungitetraose or their hydrates; a polysaccharide such as α-cyclodextrin, β-cyclodextrin, γ-cyclodextrin, or hydrates thereof. The non-reducing saccharide may include a disaccharide, and may include at least one selected from the group consisting of sucrose, trehalose, and hydrates thereof, from the viewpoint of easily obtaining excellent cycle characteristics and easily suppressing deterioration in discharge capacity.

In a case in which the non-reducing saccharide includes a disaccharide, a content of the disaccharide in the non-reducing saccharide may be 50% by mass or more, 70% by mass or more, 90% by mass or more, 95% by mass or more, 97% by mass or more, or 99% by mass or more, based on a content of the non-reducing saccharide (a total mass of the non-reducing saccharide contained in the electrolytic solution), from the viewpoint of easily obtaining excellent cycle characteristics and easily suppressing deterioration in discharge capacity. The non-reducing saccharide may consist essentially of a disaccharide (that is, an embodiment in which a content of the disaccharide is substantially 100% by mass in the non-reducing saccharide). In a case in which the non-reducing saccharide includes sucrose, a content of sucrose in the non-reducing saccharide may be within the above range from the viewpoint of easily obtaining excellent cycle characteristics and easily suppressing deterioration in discharge capacity. In a case in which the non-reducing saccharide includes trehalose, a content of trehalose in the non-reducing saccharide may be within the above range from the viewpoint of easily obtaining excellent cycle characteristics and easily suppressing deterioration in discharge capacity.

A number of a methylol group(s) (—CH₂OH) in the non-reducing saccharide may be within the following range from the viewpoint of easily obtaining excellent cycle characteristics and easily suppressing deterioration in discharge capacity. The number of the methylol group(s) may be 8 or less, 6 or less, 4 or less, 3 or less, or 2 or less. The number of the methylol group(s) may be 2 or more, or 3 or more. From these viewpoints, the number of the methylol group(s) may be from 2 to 8.

A number of an ether group(s) in the non-reducing saccharide may be within the following range from the viewpoint of easily obtaining excellent cycle characteristics and easily suppressing deterioration in discharge capacity. The number of the ether group(s) may be 16 or less, 12 or less, 8 or less, 6 or less, or 4 or less. The number of the ether group(s) may be 3 or more. From these viewpoints, the number of the ether group(s) may be from 3 to 16.

A number of a hydroxy group(s) (excluding OH structures included in methylol group) in the non-reducing saccharide is within the following range from the viewpoint of easily obtaining excellent cycle characteristics and easily suppressing deterioration in discharge capacity. The number of the hydroxy group(s) may be 16 or less, 12 or less, 8 or less, or 6 or less. The number of the hydroxy group(s) may be 5 or more, or 6 or more. From these viewpoints, the number of the hydroxy group(s) may be from 5 to 16.

A number of a carbon atom(s) in the non-reducing saccharide may be within the following range from the viewpoint of easily obtaining excellent cycle characteristics and easily suppressing deterioration in discharge capacity. The number of the carbon atom(s) may be 48 or less, 42 or less, 36 or less, 30 or less, 24 or less, or 18 or less. The number of the carbon atom(s) may be 12 or more. From these viewpoints, the number of the carbon atom(s) may be from 12 to 48.

A number of a five-membered ring structure(s) in the non-reducing saccharide may be within the following range from the viewpoint of easily obtaining excellent cycle characteristics and easily suppressing deterioration in discharge capacity. The number of the five-membered ring structure(s) may be 5 or less, 4 or less, 3 or less, 2 or less, 1 or less, or 0. The number of the five-membered ring structure(s) may be 0 or 1 or more. From these viewpoints, the number of the five-membered ring structure(s) may be from 0 to 5.

A number of a six-membered ring structure(s) in the non-reducing saccharide may be within the following range from the viewpoint of easily obtaining excellent cycle characteristics and easily suppressing deterioration in discharge capacity. The number of the six-membered ring structure(s) may be 8 or less, 4 or less, 3 or less, 2 or less, or 1. The number of the six-membered ring structure(s) may be 1 or more, or 2 or more. From these viewpoints, the number of the six-membered ring structure(s) may be from 1 to 8.

A content of the non-reducing saccharide in the electrolytic solution (a total mass of non-reducing saccharide contained in the electrolytic solution) may be within the following range based on a total mass of the electrolytic solution from the viewpoint of easily obtaining excellent cycle characteristics and easily suppressing deterioration in discharge capacity. The content of the non-reducing saccharide may be 0.01% by mass or more, 0.1% by mass or more, 0.5% by mass or more, 1% by mass or more, 1.5% by mass or more, 2% by mass or more, 3% by mass or more, or 4% by mass or more. The content of the non-reducing saccharide may be 20% by mass or less, 10% by mass or less, 8% by mass or less, 5% by mass or less, 4% by mass or less, 3% by mass or less, 2% by mass or less, or 1% by mass or less. From these viewpoints, the content of the non-reducing saccharide may be 0.01 to 20% by mass, 0.1 to 10% by mass, 1 to 8% by mass, 1 to 5% by mass, or 1 to 4% by mass.

A content of the non-reducing saccharide may be within the following range based on 100 parts by mass of the alkali metal hydroxide, from the viewpoint of easily obtaining excellent cycle characteristics and easily suppressing deterioration in discharge capacity. The content of the non-reducing saccharide may be 1 part by mass or more, 2 parts by mass or more, 3 parts by mass or more, 6 parts by mass or more, 9 parts by mass or more, or 13 parts by mass or more. The content of the non-reducing saccharide may be 30 parts by mass or less, 20 parts by mass or less, 16 parts by mass or less, 14 parts by mass or less, 12 parts by mass or less, 10 parts by mass or less, or 7 parts by mass or less. From these viewpoints, the content of the non-reducing saccharide may be from 1 to 30 parts by mass.

Examples of the carboxylic acid include terephthalic acid, isophthalic acid, phthalic acid, benzoic acid, salicylic acid, 3,4,5-trihydroxybenzoic acid, benzenehexacarboxylic acid, formic acid, acetic acid, propionic acid, butyric acid, valeric acid, oxalic acid, malonic acid, succinic acid, glutaric acid, adipic acid, aconitic acid, pyruvic acid, oxaloacetic acid, glycidyl formate, glycidyl acetate, glycidyl benzoate. Examples of the carboxylic acid salt include salts of these carboxylic acids. Examples of the carboxylic acid salt include an alkali metal salt such as a sodium salt (for example, disodium terephthalate) and a potassium salt. The carboxylic acid salt preferably includes an alkali metal salt, and more preferably includes a sodium salt, from the viewpoint of easily suppressing the decrease in discharge capacity when storing the zinc battery and from the viewpoint of easily obtaining excellent high rate discharge performance. The oxygen-containing compound preferably includes at least one selected from the group consisting of a carboxylic acid having an aromatic ring, and carboxylic acid salt having an aromatic ring, more preferably includes at least one selected from the group consisting of terephthalic acid and terephthalic acid salt, and still more preferably includes at least one selected from the group consisting of terephthalic acid and terephthalic acid sodium salt, from the viewpoint of easily suppressing the decrease in discharge capacity when storing the zinc battery and from the viewpoint of easily obtaining excellent high rate discharge performance.

A number of a carboxyl group(s) in the carboxylic acid or a number of carboxylic acid salt(s) in the carboxylic acid salt is 1 or more, and from the viewpoint of easily suppressing the decrease in discharge capacity when storing the zinc battery and from the viewpoint of easily obtaining excellent high rate discharge performance, the following ranges are preferable. The number of the carboxyl group(s) or the carboxylic acid salt group(s) is preferably 2 or more. The number of the carboxyl group(s) or the carboxylic acid group(s) is preferably 4 or less, 3 or less, or 2 or less. The number of the carboxyl group(s) or carboxylic acid salt group(s) is preferably 1 to 4.

Examples of the epoxy compound include a monofunctional epoxy compound and a polyfunctional epoxy compound. The monofunctional epoxy compound includes 1,2-epoxyethane, 1,2-epoxypropane, 1,2-epoxybutane, 1,2-epoxy-2-methylpropane, 1-phenyl-1,2-epoxyethane, epichlorohydrin, epibromohydrin, glycidyl methyl ether, allyl glycidyl ether, polyethylene oxide glycidyl ether, glycidyl amide, butyl glycidyl ether, 2-ethylhexyl glycidyl ether, stearyl glycidyl ether, lauryl glycidyl ether, butoxypolyethylene glycol glycidyl ether, phenol polyethylene glycol glycidyl ether, allyl glycidyl ether, phenyl glycidyl ether, p-methylphenyl glycidyl ether, p-ethylphenyl glycidyl ether, p-sec-butylphenyl glycidyl ether, p-tert-butylphenyl glycidyl ether, glycidyl acrylate, or glycidyl methacrylate. The polyfunctional epoxy compound includes a bisphenol A type epoxy compounds, a bisphenol F type epoxy compound, a phenol novolac type epoxy compound, a cresol novolak type epoxy compound, a polyphenol type epoxy compound, a cycloaliphatic epoxy compound, an aliphatic glycidyl ether type epoxy compound, a glycidyl ester type epoxy compound, a glycidyl diamine type epoxy compound, or a heterocyclic epoxy compound. The oxygen-containing compound preferably contains a monofunctional epoxy compound, and more preferably includes a 1,2-epoxy-2-methylpropane, from the viewpoint of easily suppressing the decrease in discharge capacity when storing the zinc battery and from the viewpoint of easily obtaining excellent high rate discharge performance.

Examples of the ether compound include a crown ether compound such as 18-crown-6, 15-crown-5, 12-crown-4, dibenzo-18-crown-6, dicyclohexano-18-crown-6, dibenzo-24-crown-8; a polyalkylene glycol such as polyethylene glycol, polypropylene glycol, and polytetramethylene glycol; or glycerin. As the ether compound, a polyether compound may be used. The oxygen-containing compound preferably includes an ether compound having a heterocycle containing an ether group, and more preferably includes 18-crown-6, from the viewpoint of easily suppressing the decrease in discharge capacity when storing the zinc battery and from the viewpoint of easily obtaining excellent high rate discharge performance.

A number of an ether group(s) in the ether compound is 1 or more, and the following range is preferable from the viewpoint of easily suppressing the decrease in discharge capacity when storing the zinc battery and from the viewpoint of easily obtaining excellent high rate discharge performance. The number of the ether group(s) is preferably 2 or more, 3 or more, 4 or more, 5 or more, or 6 or more. The number of the ether group(s) is preferably 10 or less, 9 or less, 8 or less, 7 or less, or 6 or less. The number of the ether group(s) is preferably from 1 to 10.

The oxygen-containing compound may include an ether compound represented by the following Formula (3).

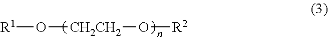

In Formula (3), n represents an integer of from 1 to 10, and R¹ and R² represent an organic group.

n in Formula (3) may be within the following range from the viewpoint of easily obtaining excellent life performance and from the viewpoint of easily obtaining excellent high rate discharge performance. n may be 8 or less, 6 or less, 4 or less, 3 or less, or 2 or less. n may be 2 or more, 3 or more, or 4 or more. From these viewpoints, n may be from 1 to 8, from 1 to 6, or from 1 to 4.

A number of an ether group(s) in the ether compound represented by Formula (3) may be within the following range from the viewpoint of easily obtaining excellent life performance and from the viewpoint of easily obtaining excellent high rate discharge performance. The number of the ether group(s) may be 9 or less, 7 or less, 5 or less, 4 or less, or 3 or less. The number of the ether group(s) may be 1 or more, 2 or more, 3 or more, 4 or more, or 5 or more. From these viewpoints, the number of the ether group(s) may be from 1 to 9, from 2 to 7, or from 2 to 5.

Both of R¹ and R² in Formula (3) may be organic groups from the viewpoint of easily obtaining excellent life performance and from the viewpoint of easily obtaining excellent high rate discharge performance. Examples of the organic group include an alkyl group, an aryl group, an ester group, a carboxyl group, or a carboxylic acid salt group (sodium salt, potassium salt, or the like). The organic group may be an alkyl group or an aryl group, and may be an alkyl group, from the viewpoint of easily obtaining excellent life performance and from the viewpoint of easily obtaining excellent high rate discharge performance.

The organic group may have a substituent. Examples of the substituent include a halogen atom, a carboxyl group, a carboxylic acid salt group, an ether group, an alkoxide group, an ester group, a ketone group, or an aldehyde group. The organic group may have no substituent from the viewpoint of easily obtaining excellent life performance and from the viewpoint of easily obtaining excellent high rate discharge performance, and may be an alkyl group having no substituent, or an aryl group having no substituent, and may be an alkyl group having no substituent.

A number of a carbon atom(s) in the organic group (including a carbon atom(s) in the substituent in the organic group) may be 8 or less, 6 or less, or 4 or less, 3 or less, 2 or less, or 1, from the viewpoint of easily obtaining excellent life performance and from the viewpoint of easily obtaining excellent high rate discharge performance. The number of the carbon atom(s) in the organic group may be 1 or more. From these viewpoints, the number of the organic group(s) may be from 1 to 8.

The alkyl group may be linear or branched. The alkyl group may be a linear alkyl group, and may be a methyl group, an ethyl group, an n-propyl group or an n-butyl group, and may be a methyl group, from the viewpoint of easily obtaining excellent life performance and from the viewpoint of easily obtaining excellent high rate discharge performance.

R¹ and R² may be the same organic group, may be the same alkyl group, and may be a methyl group, from the viewpoint of easily obtaining excellent life performance and from the viewpoint of easily obtaining excellent high rate discharge performance.

Examples of the ether compound represented by the Formula (3) include a polyoxyethylene alkyl ether compound such as a polyoxyethylene dialkyl ether (hereinafter sometimes referred to as a glyme compound), or a polyoxyethylene alkylphenyl ether. The ether compound represented by the Formula (3) may include a polyoxyethylene alkyl ether compound, and may include a glyme compound, from the viewpoint of easily obtaining excellent life performance and from the viewpoint of easily obtaining excellent high rate discharge performance.

Examples of the glyme compound include polyoxyethylene dimethyl ether, polyoxyethylene diethyl ether, polyoxyethylene dipropyl ether, polyoxyethylene dibutyl ether, polyoxyethylene dipentyl ether, polyoxyethylene dihexyl ether, polyoxyethylene diheptyl ether, polyoxyethylene dioctyl ether, or polyoxyethylene methyl ethyl ether.

The glyme compound may be a monoglyme compound such as a monoglyme (ethylene glycol dimethyl ether), an ethylene glycol diethyl ether, ethylene glycol dipropyl ether, or ethylene glycol dibutyl ether; a diglyme compound such as diglyme (diethylene glycol dimethyl ether), diethylene glycol diethyl ether, diethylene glycol dipropyl ether, or diethylene glycol dibutyl ether; a triglyme compound such as triglyme (triethylene glycol dimethyl ether), triethylene glycol diethyl ether, triethylene glycol dipropyl ether, or triethylene glycol dibutyl ether; or a tetraglyme compound such as a tetraglyme (tetraethylene glycol dimethyl ether), tetraethylene glycol diethyl ether, tetraethylene glycol dipropyl ether or tetraethylene glycol dibutyl ether. The ether compound represented by the Formula (3) may include at least one selected from the group consisting of a monoglyme compound, a diglyme compound, a triglyme compound and a tetraglyme compound, may include at least one selected from the group consisting of a monoglyme, a diglyme, a triglyme and a tetraglyme, may include at least one selected from the group consisting of a diglyme and a triglyme, and may include a diglyme, from the viewpoint of easily obtaining excellent life performance and from the viewpoint of easily obtaining excellent high rate discharge performance.

Examples of the polyoxyethylene alkylphenyl ether include polyoxyethylene methyl phenyl ether, polyoxyethylene ethyl phenyl ether, polyoxyethylene propylphenyl ether, polyoxyethylene butylphenyl ether, polyoxyethylene pentylphenyl ether, polyoxyethylene hexylphenyl, polyoxyethylene heptylphenyl ether, or polyoxyethylene nonylphenyl ether.

In a case in which the ether compound represented by the Formula (3) includes a glyme compound, a content of the glyme compound in the ether compound represented by the Formula (3) may be 50% by mass or more, 70% by mass or more 90% by mass or more, 95% by mass or more, 97% by mass or more, 99% by mass or more, based on a content of the ether compound represented by Formula (3) (a total amount of the ether compound represented by the Formula (3)), from the viewpoint of easily obtaining excellent life performance and from the viewpoint of easily obtaining excellent high rate discharge performance. The ether compound represented by the Formula (3) may consist essentially of a glyme compound (that is, an embodiment in which a content of the glyme compound is substantially 100% by mass in the ether compound represented by the Formula (3)).

A content of the ether compound represented by the Formula (3) may be within the following range from the viewpoint of easily obtaining excellent life performance and from the viewpoint of easily obtaining excellent high rate discharge performance. The content of the ether compound represented by the Formula (3) may be 1 part by mass or more, 3 parts by mass or more, 5 parts by mass or more, 5.5 parts by mass or more, or 6 parts by mass or more. The content of the ether compound represented by the Formula (3) may be 30 parts by mass or less, 20 parts by mass or less, 15 parts by mass or less, 12 parts by mass or less, 10 parts by mass or less, 8 parts by mass or less, 7 parts by mass or less, or 6.5 parts by mass or less. From these viewpoints, the content of the ether compound represented by the Formula (3) may be 1 to 30 parts by mass.

A molecular weight of the oxygen-containing compound is preferably 50 or more, 70 or more, 80 or more, 100 or more, 120 or more, 150 or more, 160 or more, 170 or more, or 180 or more, from the viewpoint of easily suppressing the decrease in discharge capacity when storing the zinc battery and from the viewpoint of easily obtaining excellent high rate discharge performance. The molecular weight of the oxygen-containing compound is preferably 2000 or less, 1500 or less, 1300 or less, 1200 or less, 1000 or less, 800 or less, or 600 or less, from the viewpoint of easily suppressing the decrease in discharge capacity when storing the zinc battery and from the viewpoint of easily obtaining excellent high rate discharge performance. From these viewpoints, the molecular weight of the oxygen-containing compound is preferably from 50 to 2,000. The molecular weight of the oxygen-containing compound may be 190 or more, 200 or more, 210 or more, 220 or more, 240 or more, 260 or more, 300 or more, 340 or more, 350 or more, 400 or more, 450 or more, or 500 or more. The molecular weight of the oxygen-containing compound may be 500 or less, 400 or less, 350 or less, 340 or less, 320 or less, 300 or less, 280 or less, 270 or less, 260 or less, 250 or less, 230 or less, 220 or less, 210 or less, 200 or less, 190 or less, or 185 or less. Note that the molecular weight is a value measured by GPC (Gel Permeation Chromatography) method. Note that in a case in which the oxygen-containing compound is a pure substance such as a monosaccharide, a disaccharide, or a glyme compound, the molecular weight of the oxygen-containing compound refers to a chemical formula weight of the compound.

As the oxygen-containing compound, it is preferable to use a compound with high solubility in the electrolytic solution. Even if the compound is not highly soluble, it can be used after removing the residue by filtration. The electrolytic solution in the present embodiment may not contain an alcohol.

A content of the oxygen-containing compound in the electrolytic solution is preferably in the following range based on a total mass of the electrolytic solution. The content of the oxygen-containing compound is preferably 0.1% by mass or more and 0.3% by mass or more, 0.5% by mass or more, 0.8% by mass or more, or 1% by mass or more, from the viewpoint of easily suppressing the decrease in discharge capacity when storing the zinc battery and from the viewpoint of easily obtaining excellent high rate discharge performance. The content of the oxygen-containing compound is preferably 5% by mass or less, 4.5% by mass or less, 4% by mass or less, 3.5% by mass or less, or 3% by mass or less, from the viewpoint of easily suppressing the decrease in discharge capacity when storing the zinc battery and from the viewpoint of easily obtaining excellent high rate discharge performance. From these viewpoints, the content of the oxygen-containing compound is preferably from 0.1% by mass to 5% by mass. The content of the oxygen-containing compound is preferably 1.2% by mass or more, 1.5% by mass or more, 1.8% by mass or more, 2% by mass or more, 2.2 mass % or more, 2.5 mass % or more, 2.7 mass % or more, or 3 mass % or more, from the viewpoint of easily suppressing the decrease in discharge capacity when storing the zinc battery. The content of the oxygen-containing compound may be 3.5% by mass or more, 4% by mass or more, 4.5% by mass or more, or 5% by mass or more.

The content of the oxygen-containing compound is preferably 2.7% by mass or less, 2.5% by mass or less, 2.2% by mass or less, 2% by mass or less, 1.7% by mass or less, 1.5% by mass or less, 1.2% by mass or less, or 1% by mass or less, from the viewpoint of easily obtaining more excellent high rate discharge performance. The content of the oxygen-containing compound may be less than 0.5 mol/L based on a total amount of the electrolytic solution.

A content of the oxygen-containing compound is preferably within the following range with respect to 1 part by mass of the surfactant. The content of the oxygen-containing compound is preferably 2 parts by mass or more, 3 parts by mass or more, 5 parts by mass or more, 10 parts by mass or more, 30 parts by mass or more, 50 parts by mass or more, 80 parts by mass or more, or 100 parts by mass or more, from the viewpoint of easily suppressing the decrease in discharge capacity when storing the zinc battery and from the viewpoint of easily obtaining excellent high rate discharge performance. The content of the oxygen-containing compound is preferably 1000 parts by mass or less, 800 parts by mass or less, 600 parts by mass or less, 500 parts by mass or less, 450 parts by mass or less, 400 parts by mass or less, 350 parts by mass or less, or 300 parts by mass or less, from the viewpoint of easily suppressing the decrease in discharge capacity when storing the zinc battery and from the viewpoint of easily obtaining excellent high rate discharge performance. From these viewpoints, the content of the oxygen-containing compound may be from 2 parts by mass to 1000 parts by mass, and preferably from 10 parts by mass to 1000 parts by mass. The content of the oxygen-containing compound is preferably 150 parts by mass or more, 200 parts by mass or more, 250 parts by mass or more, or 300 parts by mass or more, from the viewpoint of further suppressing the decrease in discharge capacity when storing the zinc battery. The content of the oxygen-containing compound may be 350 parts by mass or more, 400 parts by mass or more, 450 parts by mass or more, or 500 parts by mass or more. The content of the oxygen-containing compound is preferably 250 parts by mass or less, 200 parts by mass or less, 150 parts by mass or less, or 100 parts by mass or less.

A content of the oxygen-containing compound is preferably within the following range with respect to 100 parts by mass of the alkali metal hydroxide. The content of the oxygen-containing compound is preferably 1 part by mass or more, 1.5 parts by mass or more, 2 parts by mass or more, 2.5 parts by mass or more, or 3 parts by mass or more, from the viewpoint of easily suppressing the decrease in discharge capacity when storing the zinc battery and from the viewpoint of easily obtaining excellent high rate discharge performance. The content of the oxygen-containing compound is preferably 30 parts by mass or less, 25 parts by mass or less, 20 parts by mass or less, 16 parts by mass or less, 15 parts by mass or less, 13 parts by mass or less, 12 parts by mass or less, or 10 parts by mass or less, from the viewpoint of easily suppressing the decrease in discharge capacity when storing the zinc battery and from the viewpoint of easily obtaining excellent high rate discharge performance. From these viewpoints, the content of the oxygen-containing compound is preferably from 1 parts by mass to 30 parts by mass. The content of the oxygen-containing compound is preferably 4 parts by mass or more, 5 parts by mass or more, 6 parts by mass or more, 7 parts by mass or more, 8 parts by mass or more, or 9 parts by mass or more, from the viewpoint of further suppressing the decrease in discharge capacity when storing the zinc battery. The content of the oxygen-containing compound may be 10 parts by mass or more, 12 parts by mass or more, 13 parts by mass or more, 15 parts by mass or more, or 16 parts by mass or more. The content of the oxygen-containing compound is preferably 9 parts by mass or less, 8 parts by mass or less, 7 parts by mass or less, 6 parts by mass or less, 5 parts by mass or less, or 4 parts by mass, from the viewpoint of easily obtaining more excellent high rate discharge performance.

The electrolytic solution in the present embodiment may contain a liquid medium such as water (for example, ion-exchanged water).

Hereinafter, a nickel-zinc battery will be described as an example of a zinc battery in which the electrolytic solution in the above embodiment is used.

The zinc battery in the present embodiment includes, for example, a battery case, an electrode group (for example, an electrode plate group), and an electrolytic solution provided in the battery case. The zinc battery in the present embodiment may be either chemically formed or unformed.

The electrode group includes, for example, a positive electrode (for example, a positive electrode plate), a negative electrode (for example, a negative electrode plate), and a separator. The positive electrode and the negative electrode are adjacent to each other via one or more separator(s). That is, one or more separator(s) are provided between adjacent positive and negative electrodes. The electrode group may include a plural positive electrodes, negative electrodes, and separators. In a case in which the electrode group includes a plural positive electrodes and/or a plural negative electrodes, the positive electrodes and the negative electrodes may be alternately layered via separators. The plural positive electrodes and the plural negative electrodes may be connected, for example, with a strap.

In the zinc battery in the present embodiment, the negative electrode includes a negative electrode current collector and a negative electrode material (electrode material) supported by the current collector. The negative electrode may be one before or one after chemical formation.

The negative electrode current collector constitutes a current conduction path from the negative electrode material. The negative electrode current collector has a shape such as a flat plate or a sheet. The negative electrode current collector may be a three-dimensional network structure current collector made of a foamed metal, an expanded metal, a punched metal, a metal fiber felt, or the like. The negative electrode current collector is made of a material having conductivity and alkali resistance. Examples of the material include a material that is stable even at the reaction potential of the negative electrode (for example, a material that has an oxidation-reduction potential that is more noble than the reaction potential of the negative electrode, or a material that forms a protective film such as an oxide film on a surface of a substrate in an alkaline aqueous solution to be stabilized. Further, at the negative electrode, since a decomposition reaction of the electrolytic solution proceeds as a side reaction to generate hydrogen gas, a material with a high hydrogen overvoltage is preferable from the point that the progress of such a side reaction can be suppressed. Specific examples of the material constituting the negative electrode current collector include zinc, lead, tin, or a metal material (copper, brass, steel, nickel, or the like) plated with metals such as tin.

The negative electrode material has, for example, a layered shape. That is, the negative electrode may have a negative electrode material layer. The negative electrode material layer may be formed on or above the negative electrode current collector. In a case in which the negative electrode current collector has a portion having a three-dimensional network structure that supports the negative electrode material, the negative electrode material may be filled between the network of the current collector to form a negative electrode material layer.

The negative electrode material contains a negative electrode active material (electrode active material) containing zinc. Examples of the negative electrode active material include metal zinc, zinc oxide, or zinc hydroxide. The negative electrode active material may contain singly, or in combination of two or more kinds of these component. The negative electrode material contains, for example, metallic zinc in a fully charged state, and contains zinc oxide and zinc hydroxide in an end of discharge state. The end of discharge state refers to a state in which the battery has been discharged to an end voltage of 1.1V. The negative electrode active material is, for example, in the form of particles. That is, the negative electrode material may contain at least one selected from the group consisting of metal zinc particles, zinc oxide particles, and zinc hydroxide particles. A content of the negative electrode active material may be, for example, from 50% by mass to 95% by mass based on a total mass of the negative electrode material.

The negative electrode material may contain an additive. Examples of the additive include a binder or the like. Examples of the binder include polytetrafluoroethylene, hydroxyethylcellulose, polyethylene oxide, polyethylene, and polypropylene. A content of the binder may be, for example, from 0.5 parts by mass to 10 parts by mass with respect to 100 parts by mass of the negative electrode active material.

The positive electrode includes, for example, a positive electrode current collector, and a positive electrode material supported by the positive electrode current collector. The positive electrode may be one before or one after chemical formation.

The positive electrode current collector constitutes a current conduction path from the positive electrode material. The positive electrode current collector has a shape such as a flat plate or a sheet. The positive electrode current collector may be a three-dimensional network structure current collector made of foamed metal, an expanded metal, a punched metal, a metal fiber felt, or the like. The positive electrode current collector is made of a material having conductivity and alkali resistance. Examples of the material include a material that is stable even at the reaction potential of the positive electrode (for example, a material that has an oxidation-reduction potential that is more noble than the reaction potential of the positive electrode, or a material that forms a protective film such as an oxide film on a surface of a substrate in an alkaline aqueous solution to be stabilized. Further, at the positive electrode, since a decomposition reaction of the electrolytic solution proceeds as a side reaction to generate oxygen gas, a material with a high oxygen overvoltage is preferable from the point that the progress of such a side reaction can be suppressed. Specific examples of the material constituting the positive electrode current collector include platinum; nickel (foamed nickel, or the like.); or a metal material (copper, brass, steel, or the like), plated with metal such as nickel. Among these, a positive electrode current collector made of foamed nickel is preferably used. From the viewpoint of further improving high rate discharge performance, it is preferable that at least a portion (i.e., positive electrode material support portion) supporting the positive electrode material in the positive electrode current collector is made of foamed nickel.

The positive electrode material has, for example, a layered shape. That is, the positive electrode may have a positive electrode material layer. The positive electrode material layer may be formed on or above the positive electrode current collector. In a case in which the positive electrode material support portion of the positive electrode current collector has a three-dimensional network structure, the negative electrode material may be filled between the network of the current collector to form a negative electrode material layer.

The positive electrode material contains a positive electrode active material (electrode active material) containing nickel. Examples of the positive electrode active material include nickel oxyhydroxide (NiOOH) or nickel hydroxide. The positive electrode material contains, for example, nickel oxyhydroxide in a fully charged state, and contains nickel hydroxide in an end of discharged state. A content of the positive electrode active material may be, for example, from 50% by mass to 95% by mass based on a total mass of the positive electrode material.

The positive electrode material may further contain a component other than the positive electrode active material as an additive. Examples of the additive include a binder, a conductive agent, and an expansion inhibitor.

Examples of the binder include a hydrophilic or hydrophobic polymer. Specifically, for example, carboxymethylcellulose (CMC), hydroxyethylcellulose (HEC), hydroxypropylmethylcellulose (HPMC), sodium polyacrylate (SPA), or fluorine-based polymer (polytetrafluoroethylene (PTFE), or the like) may be used as a binder. A content of the binder may be, for example, from 0.01 parts by mass to 5 parts by mass with respect to 100 parts by mass of the positive electrode active material.

Examples of the conductive agent include a cobalt compound (metal cobalt, cobalt oxide, cobalt hydroxide, or the like). A content of the conductive agent may be, for example, from 1 part by mass to 20 parts by mass with respect to 100 parts by mass of the positive electrode active material.

Examples of the expansion inhibitor include zinc oxide or the like. A content of the expansion inhibitor may be, for example, from 0.01 pats by mass to 5 parts by mass with respect to 100 parts by mass of the positive electrode active material.

The separator may have a shape such as a flat plate or a sheet. Examples of the separator include a microporous polyolefin membrane, a microporous nylon membrane, an oxidation-resistant ion exchange resin membrane, a cellophane reprocessed resin membrane, a microporous membrane containing inorganic particles, or a polyolefin nonwoven fabric. The separator may be processed into a bag shape so that it can place the positive electrode and/or the negative electrode therein. In this case, the positive electrode and/or the negative electrode may be placed in a separator.

The separator may be used singly or in combination of two or more.

The method for producing a nickel-zinc battery described above includes, for example, a component members manufacturing process for obtaining component members of a zinc battery, and an assembly process for assembling the component members to obtain a zinc battery. In the component members manufacturing process, at least electrodes (a positive electrode and a negative electrode) are obtained.

For example, the electrode may obtain by adding a solvent (for example, water) to raw materials for an electrode material (positive electrode material and negative electrode material) and kneading them to obtain an electrode material paste (paste-like electrode material), and then forming an electrode material layer using the electrode material paste.

Examples of the raw material for the positive electrode material include a raw material for the positive electrode active material (for example, nickel hydroxide), an additive (for example, the above-mentioned binder), and the like. Examples of the raw material for the negative electrode material include a raw material for the negative electrode active material (for example, metal zinc, zinc oxide, and zinc hydroxide), an additive (for example, binders), and the like.

Examples of a method of forming the electrode material layer include a method in which the electrode material layer is obtained by applying or filling an electrode material paste onto a current collector and then drying it. A density of the electrode material layer may be increased by pressing using a roller or the like, if necessary.

In the assembly process, for example, the positive electrode and negative electrode obtained in the component members manufacturing process are alternately stacked via separator, and then the positive electrode and the negative electrode are connected with straps to produce an electrode group. Next, after placing this electrode group in a battery case, a lid is adhered to the top surface of the battery case to obtain a zinc battery (nickel-zinc battery) before chemical formation.

Subsequently, an electrolytic solution in the present embodiment is injected into the battery case of a zinc battery before chemical formation, and then left for a certain period of time. Next, a zinc battery (nickel-zinc battery) is obtained by charging under predetermined conditions for chemical formation. The chemical formation conditions may be adjusted depending on the properties of the electrode active materials (positive electrode active material and negative electrode active material). For example, a nickel-zinc battery after chemical formation may be produced by charging at 32 mA for 12 hours.

Above, an example of a nickel-zinc battery (for example, a nickel-zinc secondary battery) in which the positive electrode is a nickel electrode has been explained. A zinc battery may be also a zinc-air battery (for example, a zinc-air secondary battery) in which the positive electrode is an air electrode, and may be also a silver-zinc battery (for example, a silver-zinc secondary battery) in which the positive electrode is a silver oxide electrode.

In the zinc battery, from the viewpoint of suppressing the decline in discharge performance at low temperatures, the direct current resistance (DCR) per total electrode area at −30° C. is ideally most preferably 0 Ω·cm² which is difficult in practice, and therefore preferably at least 20 Ω·cm² or less, 15 Ω·cm² or less, 10 Ω·cm² or less, 5 Ω·cm² or less, or 1 Ω·cm² or less.

As the air electrode of the zinc-air battery, a known air electrode used in zinc-air battery may be used. The air electrode includes, for example, an air electrode catalyst, an electron conductive material, or the like. As the air electrode catalyst, an air electrode catalyst that also functions as an electron conductive material may be used.

As the air electrode catalyst, one that functions as a positive electrode in a zinc-air battery can be used, and various air electrode catalysts that can use oxygen as a positive electrode active material can be used. Air electrode catalysts include a carbon-based material with an oxidation-reduction catalytic function (graphite or the like), a metal material with an oxidation-reduction catalytic function (platinum, nickel or the like), or an inorganic oxide material with an oxidation-reduction catalytic function (perovskite-type oxide, manganese dioxide, nickel oxide, cobalt oxide, spinel oxide, or the like). A shape of the air electrode catalyst is not particularly limited, and may be, for example, particulate. An amount of the air electrode catalyst used in the air electrode may be from 5 to 70% by volume, from 5 to 60% by volume, or from 5 to 50% by volume, based on a total volume of the air electrode.

As the electron conductive material, one that has conductivity and enables electron conduction between the air electrode catalyst and the separator may be used. Examples of the electronically conductive material include a carbon black such as Ketjen black, acetylene black, channel black, furnace black, lamp black, and thermal black; a graphite such as a natural graphite such as a flaky graphite, an artificial graphite, and an expanded graphite; a conductive fiber such as a carbon fiber and a metal fiber; a metal powder of copper, silver, nickel, aluminum or the like; an organic electronic conductive material such as a polyphenylene derivative; or an arbitrary mixture thereof. A shape of the electron conductive material may be particulate or other shapes. The electron conductive material is preferably used in a form that provides a continuous phase in the thickness direction in the air electrode. For example, the electronically conductive material may be a porous material. Further, the electron conductive material may be in the form of a mixture or composite with the air electrode catalyst, and the air electrode catalyst may also function as the electron conductive material as described above.

An amount of the electron conductive material used in the air electrode may be from 10 to 80% by volume, from 15 to 80% by volume, or from 20 to 80% by volume, based on a total volume of the air electrode.

As the silver oxide electrode for the silver-zinc battery, a known silver oxide electrode used for silver-zinc battery may be used. The silver oxide electrode contains, for example, silver (I) oxide.

### EXAMPLES

Hereinafter, the present invention will be specifically explained with reference to Examples. However, the present invention is not limited to the following examples.

### Preparation of Electrolytic Solution

### (Examples 1 to 20 and Comparative Examples 1 to 2)

Ion-exchanged water, potassium hydroxide (KOH), lithium hydroxide (LiOH), and the additives shown in Table 1 below (surfactants and/or oxygen-containing compounds) were mixed to prepare electrolytic solutions (Potassium hydroxide: 30% by mass, lithium hydroxide: 1% by mass, additives: contents shown in Table 1, based on a total mass of electrolytic solution).

As the cationic surfactant, tetradecyltrimethyl ammonium bromide (special grade reagent, manufactured by Fuji Film Wako Pure Chemical Industries, Ltd.) was used.

### Production of Positive Electrode

A lattice made of nickel foam with a porosity of 95% was prepared, and the lattice was pressure-molded to obtain a positive electrode current collector. Next, cobalt-coated nickel hydroxide powder (manufactured by Gold Shine Energy Material Co., Ltd., Y6 (product name)), metal cobalt (manufactured by Nikkosi Co., Ltd., EXTRA FINE (product name)), cobalt hydroxide (manufactured by Ise Chemical Corporation), Yttrium oxide (manufactured by Fuji Film Wako Pure Chemical Corporation, reagent grade), carboxymethylcellulose (CMC, manufactured by Weiyi Chemical (Suzhou) Co., Ltd., BH90-3 (trade name)), polytetrafluoroethylene (PTFE, manufactured by Daikin Industries, Ltd., D210-C (trade name)) and ion-exchanged water were weighed and mixed, and the resulting mixed liquid was stirred to prepare a positive electrode material paste. The solid content mass ratio was set as “Nickel hydroxide:Cobalt metal:Yttrium oxide:Cobalt hydroxide: CMC: PTFE=88.0:10.3:1.0:0.3:0.3:0.1”. The water content of the positive electrode material paste was adjusted to 27.5% by mass based on a total mass of the positive electrode material paste. Next, the positive electrode material paste was applied to the positive electrode material supporting portion of the positive electrode current collector, and then dried at 80° C. for 30 minutes. Thereafter, it was pressure-molded using a roll press to obtain a positive electrode having a positive electrode material layer before chemical formation.

### Production of Negative Electrode

A punched steel plate, which is plated with tin and has a porosity of 50%, was prepared as a negative electrode current collector. Next, zinc oxide (manufactured by Mitsui Mining & Smelting Co., Ltd., general product), metal zinc (manufactured by Mitsui Mining & Smelting Co., Ltd., MA-ZB (trade name)), bismuth oxide (manufactured by Corefront Corporation, 4115CB (trade name)), hydroxyethyl cellulose (HEC, manufactured by Sumitomo Seika Chemicals Company, Limited, AV-15F (trade name)) and ion-exchanged water were weighed and mixed, and the resulting mixed liquid was stirred to prepare a negative electrode material paste. The solid content mass was set as “zinc oxide:metallic zinc:bismuth oxide: HEC=73.0:20.5:5.0:1.5”. The water content of the negative electrode material paste was adjusted to 22.5% by mass based on a total mass of the negative electrode material paste. Next, the negative electrode material paste was applied onto the negative electrode current collector, and then dried at 80° C. for 30 minutes. Thereafter, it was pressure-molded using a roll press to obtain a negative electrode having a negative electrode material (negative electrode material layer) before chemical formation.

### Preparation of Separator

For a separator, UP3355 (manufactured by UBE Corporation, trade name, air permeability: 440 sec/100 mL) was used as a microporous membrane, and Nonwoven fabric (manufactured by Nippon Kodoshi Kogyo Corporation, trade name: VL-100, air permeance: 0.3 sec/100 mL)) was used as a nonwoven fabric. The microporous membrane was subjected to hydrophilic treatment using a surfactant Triton-X100 (manufactured by Sigma-Aldrich Japan LLC) before battery assembly. The hydrophilic treatment was carried out by immersing the microporous membrane in an aqueous solution containing 1% by mass of Triton-X100 for 24 hours, and then drying it at room temperature for 1 hour. Note that the air permeance of the microporous membrane indicates a value after hydrophilic treatment. Furthermore, the microporous membrane was cut into a predetermined size, folded in half, and processed into a bag by using the folded part as the bottom and heat welding the sides. The nonwoven fabric used was one cut to a predetermined size. Note that the air permeance is a value measured by a method according to JIS P 8117:2009.

### Production of Nickel-Zinc Battery

A positive electrode (positive electrode before chemical formation) and a negative electrode (negative electrode before chemical formation) were housed separately in a bag-shaped microporous membrane. The plurality of a positive electrodes housed in a bag-shaped microporous membrane, the plurality of a negative electrode housed in another bag-shaped microporous membrane, and the plural nonwoven fabric were layered, and then the electrode plates of the same polarity are connected with straps to form an electrode group (electrode plate group) was produces. The electrode group is composed of two positive electrodes and three negative electrodes, with one nonwoven fabric placed between one positive electrode and one negative electrode (i.e., between the microporous membrane on the positive electrode side and the microporous membrane on the negative electrode side). After placing this electrode group in a battery case, a lid was adhered to the top surface of the battery case, and the electrolytic solution was injected into the battery case to obtain a nickel-zinc battery before chemical formation. Thereafter, charging was performed under the conditions of an ambient temperature of 25° C., 32 mA, and 12 hours to produce a nickel-zinc battery with a nominal capacity of 320 mAh.

### Evaluation of DC Resistance

Using the nickel-zinc battery of the above examples and comparative examples, constant voltage charging at 1.9V (charging was terminated when the current value attenuated to 16 mA (0.05 C)) was performed in an environment of 25° C. Afterwards, constant current discharge was performed at current values of 160 mA (0.5 C), 320 mA (1 C), 640 mA (2 C), and 960 mA (3 C) for 1 second respectively in an environment of −30° C., and then direct current resistance (DCR) per a total electrode area was calculated using the following formula. After the constant current discharge, each battery was charged at a constant current of 1 C (current value 320 mA) in an environment of −30° C. so that the discharge capacity=the charge capacity. Note that the unit “C” is a relative expression of the magnitude of the current when discharging the rating capacity from a fully charged state at a constant current. The unit “C” means “discharge current value (A)/battery capacity (Ah)”. For example, the current that allows the rated capacity to be completely discharged in one hour is defined as “1 C”, and the current value that allows the rated capacity to be completely discharged in two hours is defined as “0.5 C”.

$$DCR = \{ ( Δ {V}_{0.5 C} - V ) ( {I}_{0.5 C} - I ) + ( Δ {V}_{1. C} - V ) + ( Δ {V}_{2. C} - V ) ( {I}_{2. C} - I ) + ( Δ {V}_{3. C} - V ) ( {I}_{3. C} - I ) \} / \{ {( {I}_{0.5 C} - I )}^{2} + {( {I}_{1. C} - I )}^{2} + {( {I}_{2. C} - I )}^{2} + {( {I}_{3. C} - I )}^{2} \} \cdot {A}_{E}$$

Here, I=(I_{0.5C}+I_{1.0C}+I_{2.0C}+I_{3.0C})/4, V=(ΔV_{0.5C}+ΔV_{1.0C}+ΔV_{2.0C}+ΔV_{3.0C})/4, and each of I_{0.5 C}, I_{1.0 C}, I_{2.0 C} and I_{3.0 C} respectively indicates a discharge current value corresponding to the discharge rate of 0.5 C, 1.0 C, 2.0 C and 3.0 C, and each of ΔV_{0.5C}, ΔV_{1.0C}, ΔV_{2.0C} and ΔV_{3.0C} respectively indicates a voltage change after 1 second in the discharge current value at a respective discharge current value. A_{E} indicates a total electrode area.

### Evaluation of Cycle Life Performance

At 70° C., the nickel-zinc battery was charged at a constant voltage of 1.88V at 105.7 mA (0.33 C) until the current value attenuated to 16 mA (0.05 C), and then the nickel-zinc battery was discharged at a constant current of 105.7 mA (0.33 C) until the voltage value reached 1.1 V, which is as one cycle. The cycle life performance was defined as a number of cycles at which the discharge capacity retention rate with respect to the first cycle discharge capacity reached 70%.

TABLE 1

| | Additive | | | | | |
|---|---|---|---|---|---|---|
| | | | Oxygen-containing | | | Cycle |
| | Surfactant | | compound | | | number |
| | | Content | | Content | DCR −30° C. | 70° C. |
| | Compound | (% by mass) | Compound | (% by mass) | (Ω · cm²) | (Cycle) |
| Example 1 | A | 0.010 | B | 0 | 7.2 | 15 |
| Example 2 | A | 0.100 | B | 0 | 7.8 | 18 |
| Example 3 | A | 0.010 | B | 2 | 21.1 | 124 |
| Example 4 | A | 0.100 | B | 2 | 11.8 | 128 |
| Example 5 | A | 0.100 | B | 3 | 19.2 | 152 |
| Example 6 | A | 0.250 | B | 2 | 11.6 | 129 |
| Example 7 | A | 0.250 | B | 3 | 18.5 | 154 |
| Example 8 | A | 0.500 | B | 2 | 10.4 | 129 |
| Example 9 | A | 0.500 | B | 3 | 17.5 | 155 |
| Example 10 | A | 1.000 | B | 3 | 15.3 | 153 |
| Example 11 | A | 0.500 | C | 2 | 8.3 | 125 |
| Example 12 | A | 0.500 | C | 3 | 8.6 | 138 |
| Example 13 | A | 0.500 | D | 2 | 12.4 | 125 |
| Example 14 | A | 0.500 | D | 3 | 19.6 | 151 |
| Example 15 | A | 0.500 | E | 2 | 8.6 | 121 |
| Example 16 | A | 0.500 | E | 3 | 9.1 | 132 |
| Example 17 | A | 0.500 | F | 2 | 8.4 | 129 |
| Example 18 | A | 0.500 | F | 3 | 8.8 | 141 |
| Example 19 | A | 0.500 | G | 2 | 8.7 | 132 |
| Example 20 | A | 0.500 | G | 3 | 9.0 | 146 |
| Comparative | A | 0.005 | B | 2 | 23.6 | 124 |
| Example 1 | | | | | | |
| Comparative | A | 0.005 | B | 3 | 29.4 | 150 |
| Example 2 | | | | | | |

In Table 1, each compounds A to G is as follows.
A: Tetradecyltrimethylammonium bromide
B: Sucrose
C: Diglyme
D: Glucose
E: Monoglyme
F: Triglyme
G: Tetraglyme

The DCR of the zinc battery of Examples 1 and 2 that do not contain oxygen-containing compounds is lower than that of the zinc battery of Comparative Examples 1 and 2.

The cycle life performance of the zinc battery of Examples 4 to 20 and Comparative Examples 1 to 2 was comparable, and the DCR of the zinc batteries of Examples 4 to 20 was significantly reduced compared to the DCR of the zinc batteries of Comparative Examples 1 to 2. This is thought to be due to improved spread of the electrolytic solution to a surface of the active material.

The disclosures of Japanese Patent Application No. 2021-138859 filed on Aug. 27, 2021 is incorporated herein by reference in their entirety.

All documents, patent applications, and technical standards described in the present specification are incorporated herein by reference to the same extent as if each individual document, patent application, or technical standard were specifically and individually indicated to be incorporated by reference.

1. An electrolytic solution for a zinc battery comprising an alkali metal hydroxide and a surfactant,
wherein a content of the surfactant is 0.01% by mass or more with respect to a total mass of the electrolytic solution for a zinc battery.

2. The electrolytic solution for a zinc battery according to claim 1, wherein the alkali metal hydroxide comprises potassium hydroxide.

3. The electrolytic solution for a zinc battery according to claim 1, wherein the surfactant comprises at least one selected from the group consisting of a cationic surfactant, a nonionic surfactant and an anionic surfactant.

4. The electrolytic solution for a zinc battery according to claim 1, further comprising an organic compound containing an oxygen atom.

5. The electrolytic solution for a zinc battery according to claim 4, wherein the organic compound containing an oxygen atom comprises at least one selected from the group consisting of a carboxy group, a carboxylate salt group, a hydroxyl group, an epoxy group and an ether group.

6. The electrolytic solution for a zinc battery according to claim 4, wherein the organic compound containing an oxygen atom comprises an ether compound having a heterocycle containing an ether group.

7. The electrolytic solution for a zinc battery according to claim 4, wherein the organic compound containing an oxygen atom comprises an ether compound represented by the following Formula (3), 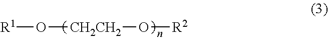
wherein, in Formula (3), n represents an integer of from 1 to 10, and each of R¹ and R² represents an organic group.

8. The electrolytic solution for a zinc battery according to claim 7, wherein the organic group in Formula (3) is an alkyl group or an aryl group.

9. The electrolytic solution for a zinc battery according to claim 7, wherein the ether compound represented by Formula (3) comprises a glyme compound.

10. The electrolytic solution for a zinc battery according to claim 9, wherein the glyme compound comprises at least one selected from the group consisting of a monoglyme, a diglyme, a triglyme and a tetraglyme.

11. A zinc battery, comprising a positive electrode, a negative electrode, and the electrolytic solution for a zinc battery according to claim 1.
